(19) United States
(12) Patent Application Publication
(10) Pub. No.: US 2006/0233359 A1
(43) Pub. Date: Oct. 19, 2006

(54) Apparatus, method and system for providing a broadcasting service in a digital broadcasting system with a single frequency network

(75) Inventors: Suk-Jin Jung, Yongin-si (KR); Hee-Jin Roh, Suwon-si (KR); Kyung-Ha Lee, Seongnam-si (KR)

Correspondence Address: DILWORTH & BARRESE, LLP, 333 EARLE OVINGTON BLVD., UNIONDALE, NY, 11553, US

(73) Assignee: Samsung Electronics Co., Ltd., Suwon-si (KR)

(21) Appl. No.: 11/406,598

(22) Filed: Apr. 19, 2006

(30) Foreign Application Priority Data
Apr. 19, 2005 (KR) 2005-32521

(51) Int. Cl. H04L 9/30

(52) U.S. Cl. 380/30

(57) ABSTRACT

An apparatus, method, and system for providing a broadcasting service in a Digital Multimedia Broadcasting (DMB) system with a Single Frequency Network (SFN). Networks of shadow and non-shadow regions can be distinguished in the digital broadcasting system. A conditional access system can be used in the shadow region. A terminal can select a service network. A broadcasting providing server encrypts broadcasting service data, generates private and public keys into which predetermined encryption keys are divided to decrypt the encrypted broadcasting service data, sets at least one broadcasting transmitter for transmitting the private key and/or at least one broadcasting transmitter for transmitting the public key, and provides the encryption keys along with the encrypted broadcasting service data. Broadcasting transmitters transmit the encrypted broadcasting service data received from the broadcasting providing server and the private key using the SFN. At least one of the broadcasting transmitters further transmits the public key.

### PRIORITY

This application claims priority under 35 U.S.C. § 119 to an application entitled “Apparatus, Method, and System for Providing a Broadcasting Service in a Digital Broadcasting System with a Single Frequency Network” filed in the Korean Intellectual Property Office on Apr. 19, 2005 and assigned Serial No. 2005-32521, the contents of which are incorporated herein by reference.

### BACKGROUND OF THE INVENTION

1. Field of the Invention

The present invention generally relates to an apparatus, method, and system for providing a digital broadcasting service, and more particularly to an apparatus, method, and system for providing a broadcasting service in a Digital Multimedia Broadcasting (DMB) system with a Single Frequency Network (SFN).

2. Description of the Related Art

Broadcasting services are provided to all users with terminals. These broadcasting services are classified into an audio broadcasting service such as radio broadcasting for providing only audio, a video broadcasting service such as television for providing audio and video services, and a multimedia broadcasting service including audio, video, and data services. The broadcasting services are based on an analog system, and are currently being developed into digital broadcasting with the rapid development of various technologies. Moreover, the broadcasting services are being developed in various systems such as a multimedia service system of a wired network for providing data of high image quality at a high rate by wire, a system for providing a multimedia service using an artificial satellite, and a system simultaneously using a wire and an artificial satellite, without use of a system for providing a service on the basis of a transmission tower conventionally managed by a broadcasting station.

Recently, a Digital Multimedia Broadcasting (DMB) system, as one of the above-described systems, is being actively commercialized. This DMB system has been derived from Digital Audio Broadcasting (DAB) and is based on European Research Coordination Agency (Eureka) Project-147, serving as the technical standard of DAB in Europe. Hereinafter, a DMB service will be considered a multimedia broadcasting service including a DAB service. The DMB service is divided into terrestrial DMB and satellite DMB for providing a service using an artificial satellite. The satellite DMB system multiplexes data in Code Division Multiplexing (CDM), divides channels, and transmits the multiplexed data through the channels. On the other hand, the terrestrial DMB system multiplexes data in Orthogonal Frequency Division Multiplexing (OFDM), divides channels, and transmits the multiplexed data through the channels.

Among the multiplexing systems, the OFDM system converts a serially input symbol stream into parallel and then modulates and transmits parallel symbols through a plurality of orthogonal subcarriers. The OFDM system is more robust to a frequency-selective multipath-fading channel as compared with a conventional single-carrier modulation scheme. Because there is a frequency selective channel in a frequency band occupied by a plurality of subcarriers and a frequency nonselective channel in each subcarrier band in view of a receiver side, a channel can be easily compensated through a simple channel equalization process. Specifically, the OFDM system copies a second half part of each OFDM symbol, attaches the copied part as a Cyclic Prefix (CP) before the OFDM symbol, and transmits the OFDM symbol, thereby removing InterSymbol Interference (ISI) from a previous symbol. A plurality of broadcasting transmitters can configure a Single Frequency Network (SFN) using the OFDM system. Accordingly, the OFDM system is suitable for a broadcasting service.

Due to the above-described merits, legislation for providing terrestrial DMB service has been prepared in some countries such as South Korea. A method for promoting public benefit has been provided by offering a free broadcasting service through terrestrial DMB. That is, anyone can watch high-quality programs if he or she has equipment capable of receiving the broadcasting.

In the case of terrestrial DMB, broadcasting signals are transmitted through broadcasting transmitters installed on the ground. Because the broadcasting transmitters are installed on the ground for public benefit as described above, there is a problem in that the broadcasting transmitters are to be installed in a country for free. Due to this problem, many broadcasting transmitters cannot be installed by the government of a country rather than by a general service provider for pay communication. When the number of broadcasting transmitters installed on the ground is limited, broadcasting service may not be received. For example, when a signal is weak at a distance far from a broadcasting transmitter, normal broadcasting service cannot be provided. When a terminal user is located in a shadow region due to specific buildings or geographical features, broadcasting service cannot be provided.

On the other hand, broadcasting service providers for providing broadcasting services different from terrestrial DMB service have various broadcasting service contents. Moreover, the broadcasting service providers adopt a so-called Conditional Access System (CAS) for selectively providing the broadcasting service contents according to service requirements and entitlements of users. The CAS is a control system for limiting reception in an unregistered terminal that is not entitled to receive data when the data is transmitted from a transmitter to multiple terminals.

The broadcasting service providers can implement, for example, a differential billing system by controlling service reception entitlement of each terminal using the CAS. The terrestrial DMB system is advantageous in that it can provide free information to more viewers as in the conventional terrestrial Television (TV) broadcasting. According to the introduction of a special CAS, service fees can be considered when an additional relay is required as in, for example, a shadow region.

To implement the above-described CAS, a relay network operable for a broadcasting transmitter located in a non-shadow region needs to be distinguished from a different relay network operable for a broadcasting transmitter located in a shadow region. With the merit of the above-described SFN, unnecessary service fees are not charged to a user located in the non-shadow region, or loss in the non-shadow region is absent as a relay network in which service fees are charged is expanded. That is, a need exists for a broadcasting system in which a broadcasting service can be provided without special service fees in the non-shadow region without signal loss and service fees can be charged only in the shadow region.

### SUMMARY OF THE INVENTION

It is an object of the present invention to provide an apparatus, method, and system for providing a broadcasting service that can distinguish a network of a shadow region and a network of a non-shadow region in a digital broadcasting system.

It is another object of the present invention to provide an apparatus, method, and system for providing a broadcasting service that can exploit a conditional access system in a shadow region when networks of shadow and non-shadow regions are divided in a digital broadcasting system.

It is yet another object of the present invention to provide an apparatus, method, and system for enabling a terminal to select a service network when networks of shadow and non-shadow regions are divided to provide a service in a digital broadcasting system.

In accordance with an aspect of the present invention, there is provided a digital broadcasting system for providing a broadcasting service through a single frequency network, including a broadcasting providing server for encrypting broadcasting service data, generating a private key and a public key into which predetermined encryption keys are divided to decrypt the encrypted broadcasting service data, setting at least one broadcasting transmitter for transmitting the private key and/or at least one broadcasting transmitter for transmitting the public key, and providing the encryption keys along with the encrypted broadcasting service data; and broadcasting transmitters for transmitting the encrypted broadcasting service data received from the broadcasting providing server and the private key using the single frequency network, at least one of the broadcasting transmitters further transmitting the public key.

In accordance with another aspect of the present invention, there is provided a method for providing a broadcasting service through a single frequency network in a digital broadcasting system, which includes encrypting broadcasting service data, generating a private key and a public key into which predetermined encryption keys are divided to decrypt the encrypted broadcasting service data, and transmitting the encrypted broadcasting service data and the encryption keys to broadcasting transmitters for transmitting the private key and/or the public key; transmitting the encrypted broadcasting service data and the private key from the broadcasting transmitters using the single frequency network; and further transmitting the public key from at least one of the broadcasting transmitters.

In accordance with another aspect of the present invention, there is provided a reception apparatus for receiving encrypted broadcasting service data from at least one broadcasting transmitter in a digital broadcasting system with the at least one broadcasting transmitter for transmitting the encrypted broadcasting service data through a single frequency network, including a receiver for receiving a public key and/or a private key for decrypting broadcasting service data from a frame of the broadcasting service data; a decryption key generator for receiving the public key and/or private key and generating at least one Control Word (CW) for decrypting the broadcasting service data; and control means for selecting one of the at least one generated CW according to a designated condition and decrypting the broadcasting service data.

In accordance with yet another aspect of the present invention, there is provided a reception method for receiving encrypted broadcasting service data from at least one broadcasting transmitter in a digital broadcasting system with the at least one broadcasting transmitter for transmitting the encrypted broadcasting service data through a single frequency network, which includes receiving a public key and/or a private key for decrypting the broadcasting service data from a frame of the broadcasting service data; generating at least one Control Word (CW) for decrypting the broadcasting service data; and selecting one of the at least one generated CW according to a designated condition and decrypting the broadcasting service data.

### BRIEF DESCRIPTION OF THE DRAWINGS

The above and other objects and aspects of the present invention will be more clearly understood from the following detailed description taken in conjunction with the accompanying drawings, in which:

FIG. 1 is a conceptual diagram illustrating a structure of a terrestrial Digital Multimedia Broadcasting (DMB) system in accordance with the present invention;

FIG. 2 is a block diagram illustrating an example of structures of a broadcasting transmitter and a broadcasting service-providing device of a broadcasting station or broadcasting service provider in accordance with the present invention;

FIG. 3 illustrates a frame format for transmitting broadcasting traffic in the terrestrial DMB system;

FIG. 4 is a flowchart illustrating a control process performed in a broadcasting controller of the broadcasting station in accordance with the present invention;

FIG. 5 is a flowchart illustrating a control process when a public key value is transmitted from a transmitter controller of the broadcasting transmitter;

FIG. 6 is a block diagram illustrating an internal structure of a broadcasting receiver for receiving DMB broadcasting in accordance with the present invention; and

FIG. 7 is a flowchart illustrating a control process of the receiver when DMB broadcasting service data is received in accordance with the present invention.

### DETAILED DESCRIPTION OF THE PREFERRED EMBODIMENTS

Exemplary embodiments of the present invention will be described in detail herein below with reference to the accompanying drawings. In the following description, concrete details will be described for a better understanding of the present invention. Those skilled in the art will appreciate that the present invention can be implemented without these details. In the following description, detailed descriptions of functions and configurations incorporated herein that are well known to those skilled in the art are omitted for clarity and conciseness.

A terrestrial Digital Multimedia Broadcasting (DMB) system is provided as an example of a digital broadcasting system. It should be noted that the terrestrial DMB system can also include a Digital Audio Broadcasting (DAB) system.

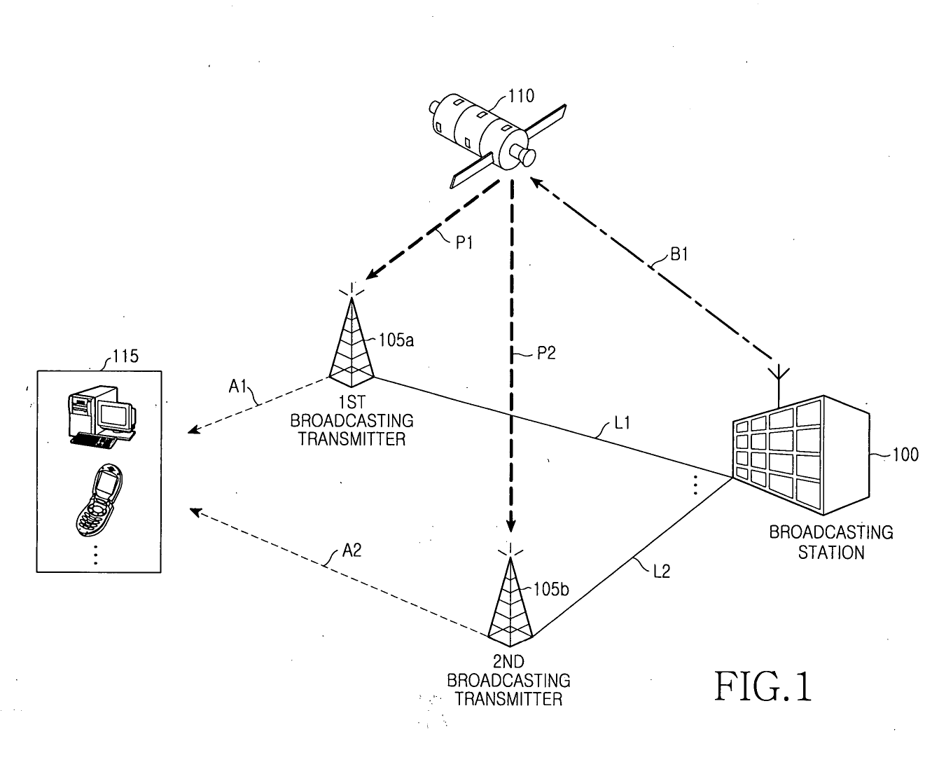

FIG. 1 is a conceptual diagram illustrating a structure of the terrestrial DMB system in accordance with the present invention. A broadcasting network transmits broadcasting service data from a broadcasting station 100. The broadcasting station 100 can be replaced with a broadcasting server capable of providing DMB broadcasting service data to a broadcasting transmitter in accordance with the present invention. That is, a predetermined service provider can provide a DMB broadcasting service through the broadcasting server, and a predetermined server within the broadcasting station 100 can provide the DMB broadcasting service. Hereinafter, the provider and server are referred to as the broadcasting stations. Broadcasting service data transmitted from the broadcasting station is primarily an encrypted signal. The encrypted broadcasting service data transmitted from the broadcasting station 100 is transmitted to terminals 115 through a plurality of broadcasting transmitters 105a, 105b, etc. The broadcasting station 100 can adopt three methods to transmit the encrypted broadcasting service data to the plurality of broadcasting transmitters 105a, 105b, as described in more detail below.

The first method utilizes an artificial satellite. That is, the broadcasting station 100 transmits the encrypted broadcasting service data to an artificial satellite 110, which can transmit the encrypted broadcasting service data to the broadcasting transmitters 105a, 105b using Time Division Multiplexing (TDM). The broadcasting transmitters 105a, 105b receive the broadcasting service data sent from the artificial satellite 110 and transmit encryption keys for decrypting the broadcasting service data according to the given schemes. At this time, the encryption keys to be transmitted along with the broadcasting service data are sent according to the schemes allocated to the broadcasting transmitters. The encryption keys will be described below in more detail with reference to the accompanying drawings.

The second method sends the broadcasting service data through wired cables or transmission networks for connecting the broadcasting station 100 to the broadcasting transmitters 105a, 105b. In FIG. 1, the wired cables or transmission networks are connected between the broadcasting station 100 and the broadcasting transmitters 105a, 105b as indicated by L1 and L2. Therefore, the broadcasting transmitters 105a, 105b can receive the transmitted broadcasting service data through the wired cables or transmission networks and can transmit the encryption keys in encryption key transmission schemes assigned along with the broadcasting service data.

The third method sends the broadcasting service data to particular broadcasting transmitters through the artificial satellite 110 and sends the broadcasting service data to the remaining broadcasting transmitters through the wired cables or transmission networks. That is, the broadcasting station 100 sends encrypted broadcasting service data to the particular broadcasting transmitters through the artificial satellite 110, and sends the broadcasting service data to the remaining broadcasting transmitters through the wired cables or transmission networks. Then, the associated broadcasting transmitters are synchronized with a particular synchronization signal, and simultaneously send the broadcasting service data and the encryption keys.

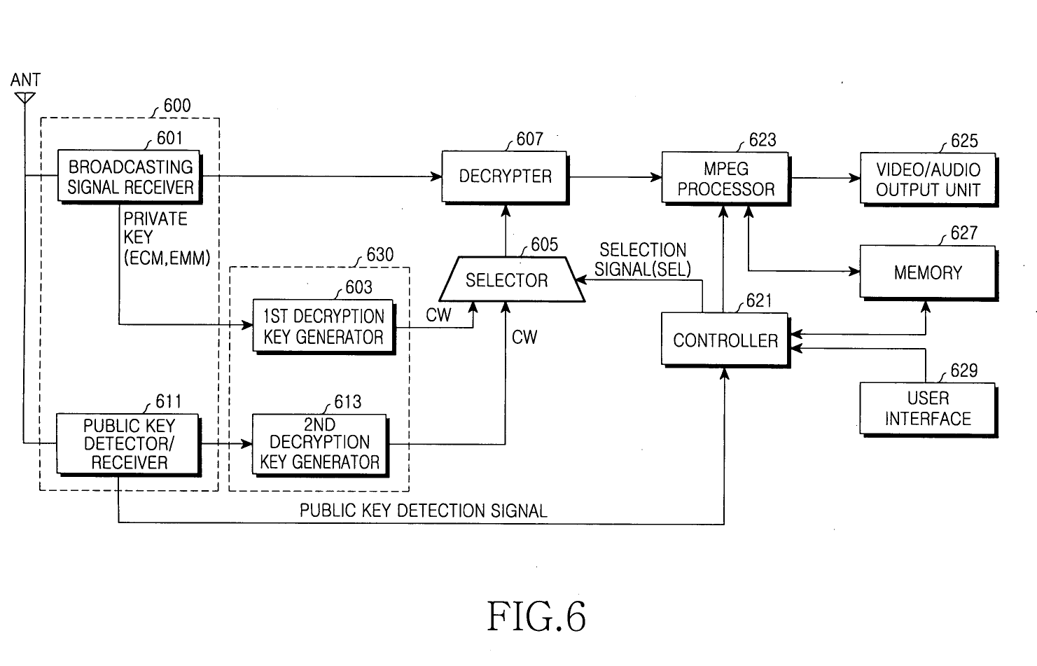

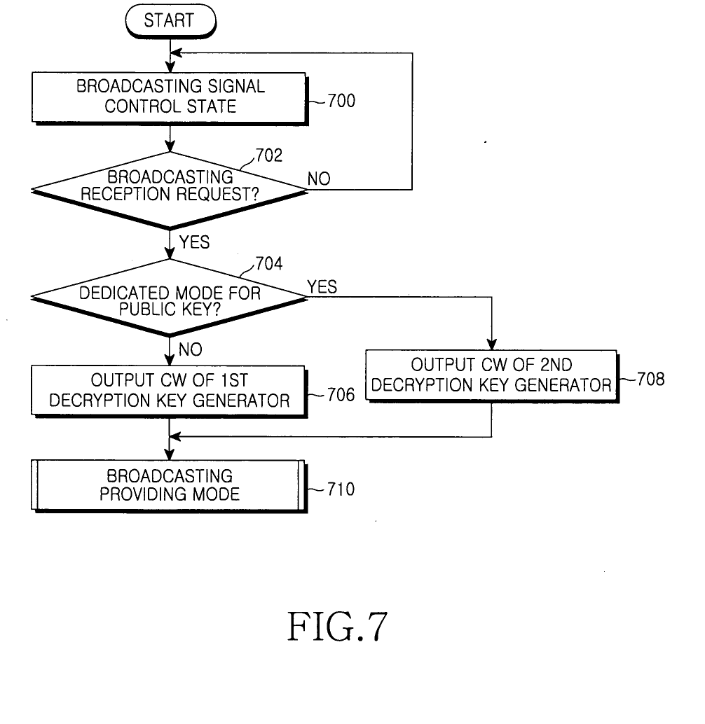

When the broadcasting service data and the encryption keys are sent, the terminals 115 receive the broadcasting service data and the encryption keys, thereby receiving a broadcasting service. The terminals 115 can be a mobile phone, a Personal Digital Assistant (PDA), a notebook computer, and so on provided with a broadcasting receiver. A structure and operation for receiving the broadcasting service in these terminals will be described below in more detail with reference to FIGS. 6 and 7.

A method for providing the broadcasting service in accordance with the present invention in a broadcasting network configured as described above will now be described.

First, it is assumed that a broadcasting transmitter located in a non-shadow region is the first broadcasting transmitter 105a and a broadcasting transmitter located in a shadow region is the second broadcasting transmitter 105b. Thus, the first broadcasting transmitter 105a provides a broadcasting service in the wide non-shadow region, and the second broadcasting transmitter 105b provides a broadcasting service in the shadow region. In accordance with the present invention, the first and second broadcasting transmitters 105a and 105b configure a Single Frequency Network (SFN), and transmit the same broadcasting service data. It is preferred that the broadcasting station 100 transmits the broadcasting service data in the same format such that the first and second broadcasting transmitters 105a and 105b can transmit the same broadcasting service data.

Because the first and second broadcasting transmitters 105a and 105b send the same broadcasting service data as described above, a terminal located in a specific region in which the non-shadow region and the shadow region are overlapped, can also reliably receive the broadcasting service data from the first broadcasting transmitter 105a installed in the non-shadow region as well as that from the second broadcasting transmitter 105b installed in the shadow region. This is because a broadcasting service data transmission scheme adopts Orthogonal Frequency Division Multiplexing (OFDM), and signals transmitted from different broadcasting transmitters can be interpreted as signals received through multiple paths.

The first broadcasting transmitter 105a located in the non-shadow region generates and transmits a public key serving as the encryption key in accordance with the present invention. Moreover, the first broadcasting transmitter 105a can generate and transmit both public and private keys serving as the encryption keys in accordance with the present invention. For example, this enables the broadcasting service to be decrypted using the private key also in the non-shadow region.

The public key is received in all users and is a key value for decrypting an encrypted broadcasting service. On the other hand, the second broadcasting transmitter 105b located in the shadow region does not transmit the public key. That is, the second broadcasting transmitter 105b transmits broadcasting service data using only a private key as the encryption key included and transmitted therein. Because the terminal 115 located in the shadow region cannot receive the public key, an encrypted broadcasting service cannot be decrypted even though the broadcasting service data is received as if a conditional access system (CAS) is selectively applied. A broadcasting service can be selectively provided such that an associated user receives the private key according to his/her service requirement and entitlement.

On the other hand, the first broadcasting transmitter 105a can selectively use a gap filler capable of covering the non-shadow region or a broadcasting transmission tower provided in a country for free. It is preferred that the second broadcasting transmitter 105b uses a gap filler capable of covering the shadow region.

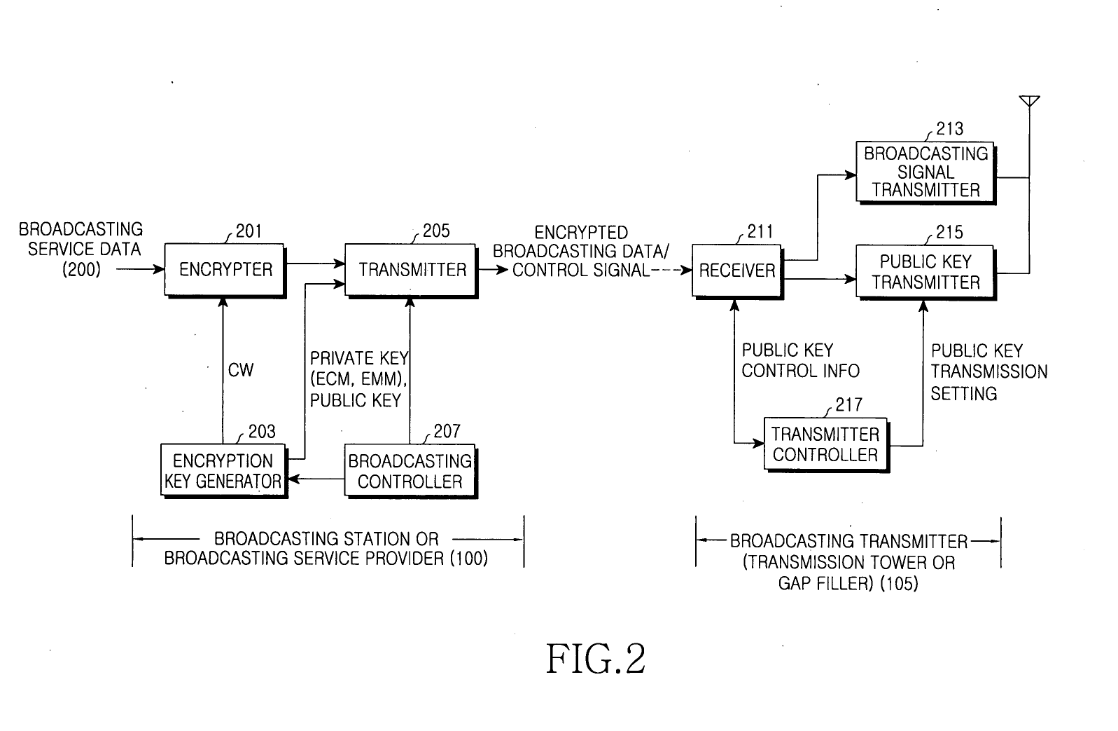

FIG. 2 is a block diagram illustrating an example of structures of a broadcasting transmitter and a broadcasting service-providing device of a broadcasting station or broadcasting service provider in accordance with the present invention.

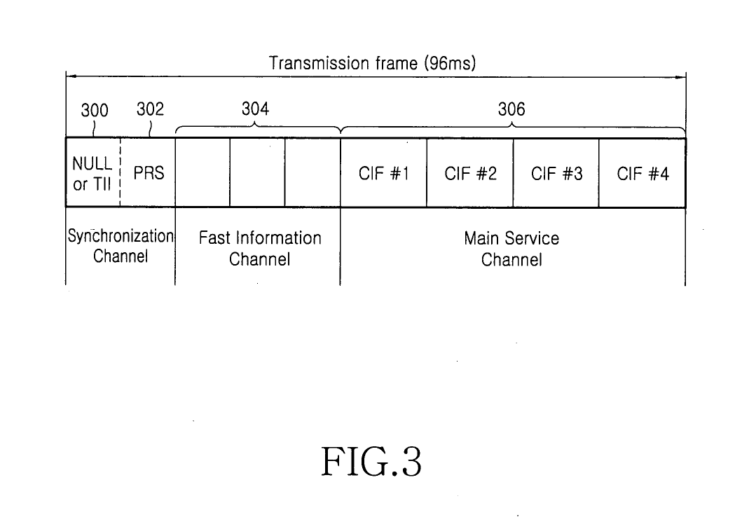

First, the structure of the broadcasting service providing device of the broadcasting station 100 or the broadcasting service provider in accordance with the present invention will be described. Broadcasting service data 200 to be transmitted to the terminal is input to an encrypter 201. The encrypter 201 encrypts the input broadcasting service data. At this time, an encryption scheme may use a scrambling scheme, or may use another encryption scheme. To encrypt the broadcasting service data 200, an encryption key generator 203 generates a Control Word (CW) as an encryption key for encrypting the broadcasting service data 200, and provides the generated CW to the encrypter 201. Moreover, the encryption key generator 203 generates a private key value to be allocated to a terminal desiring to receive a service in the shadow region and a public key value to be allocated to a terminal desiring to receive a service in the non-shadow region, and provides the generated key values to a transmitter 205. The terminal of a pay service subscriber preferably uses the private key in the non-shadow region according the present invention, but can also use the public key. At this time, the private key value can use a value of a well-known Entitlement Checking Message (ECM) or Entitlement Management Message (EMM). The public key value can be used as a value of Transmitter Identification Information (TII) in accordance with the present invention. A method for transmitting public and private key values for decrypting the encrypted broadcasting service data will be described in more detail with reference to FIG. 3.

In FIG. 2, a broadcasting controller 207 generates a control signal in an update period of an encryption key and provides the generated control signal to the encryption key generator 203. The broadcasting controller 207 generates a control signal for a broadcasting transmitter for transmitting a private key and a broadcasting transmitter for transmitting a public key, and then transmits the control signal through the transmitter 205. The broadcasting controller 207 can be configured to be connected to an operator interface (not illustrated in FIG. 2) capable of being manually operated by an operator. That is, the broadcasting controller 207 can perform a control operation such that a generation period value of an encryption key can be changed and broadcasting transmitters for transmitting a public key value can be extended or reduced. The transmitter 205 sends encrypted broadcasting service data received from the encrypter 201 and a control signal including the public key and the private key received from the encryption key generator 203 to the broadcasting transmitters in one of the above-described three methods as described with reference to FIG. 1. Hereinafter, information for setting whether the public key is to be transmitted among the control signals to be transmitted to the broadcasting transmitters is referred to as public key control information.

Next, referring back to FIG. 1, and to FIG. 2 as well, a structure and operation of the broadcasting transmitter 105 will be described. The broadcasting transmitter 105 receives encrypted broadcasting data and a control signal via a wired or wireless path from the broadcasting station 100. Under control of the transmitter controller 217, the receiver 211 outputs the encrypted broadcasting data among the received signals to a broadcasting signal transmitter 213, outputs a public key value to a public key transmitter 215, and outputs public key control information to transmitter controller 217. Using the public key control information, the transmitter controller 217 determines whether to transmit a public key through the public key transmitter 215. The transmitter controller 217 can set the transmission or interruption of a public key value.

Therefore, the public key transmitter 215 can be configured to transmit or interrupt the public key value. Among the broadcasting transmitters 105, a broadcasting transmitter responsible for a non-shadow region can be configured to unconditionally output the public key value through the public key transmitter 215. That is, a broadcasting transmitter can be limited to the shadow region such that the transmitter controller 217 can control public key transmission. This structure can prevent a public key value from being transmitted to the non-shadow region. The transmitter controller 217 of the shadow region can be configured to transmit a public key value such that free broadcasting can be limitedly provided in the shadow region according to particular cases, for example, such as a state of national emergency, a particular time of free broadcasting of a provider, or a particular purpose of a provider.

The broadcasting signal transmitter 213 transmits broadcasting service data including a private key value according to terrestrial DMB. In the embodiment of FIG. 2, there is provided the structure in which public and private keys are transmitted through the broadcasting station or broadcasting service provider. Alternatively, there may be provided a structure in which at least one of the public and private keys is directly transmitted through the broadcasting transmitter 105.

FIG. 3 illustrates a frame format for transmitting broadcasting traffic in terrestrial DMB. The frame format for transmitting broadcasting traffic in the terrestrial DMB and a method for transmitting a public key value in accordance with the present invention will be described with reference to FIG. 3.

A broadcasting frame illustrated in FIG. 3 is one broadcasting frame, and is transmitted in a unit of 96 ms. The broadcasting traffic has a synchronization channel at its head end. The synchronization channel is divided into two parts. First, the synchronization channel has a null interval 300 in which a TII is transmitted or no data is transmitted. In the present invention, a TII value to be transmitted in the null interval 300 is newly defined. That is, the TII can be conventionally used as transmitter identification information. However, the present invention can use the TII to decode a public key value. Because the TII value is constructed with 12 bits in the DMB standard, it can be received in one or more frames and can be used as a public key value. Herein, the number of TII bits can be variably set, and reception performance can be improved by constructing the TII with an orthogonal set corresponding to a predetermined number of bits.

When the TII value is used as the public key value, the TII value is periodically changed. This change can be controlled in the broadcasting controller 207 provided in the broadcasting station 100 of FIG. 2. If the TII value is not used to transmit the public key value, a predetermined number of bits corresponding to the public key value can be transmitted in the null interval in place of the TII. Thus, the public key value can be transmitted through the synchronization channel. Phase reference symbols are transmitted in a Phase Reference Symbol (PRS) interval 302 of the synchronization channel.

On the other hand, a private key value can be transmitted using an ECM or EMM value in a Fast Information Channel (FIC) 304. If a capacity of the FIC is insufficient to transmit the ECM or EMM value, the last subchannel #63 of a main service channel 306 can be configured to additionally transmit the ECM or EMM value. The main service channel 306 is configured by, for example, 4 Common Interleaved Frames (CIFs), and transmits encrypted broadcasting traffic.

When the frame is constructed as described above, a broadcasting transmitter for transmitting a public key value sends a TII value indicating the public key at the head end of the synchronization channel or different information indicating the public key value. A broadcasting transmitter does not send any data at the head end of the synchronization channel when not transmitting the public key value. Because subsequent data sent from the broadcasting transmitters constructs an identical OFDM symbol, the effect of multipath transmission is obtained when frames are sent from different broadcasting transmitters and interchannel interference is absent, such that the SFN can be implemented.

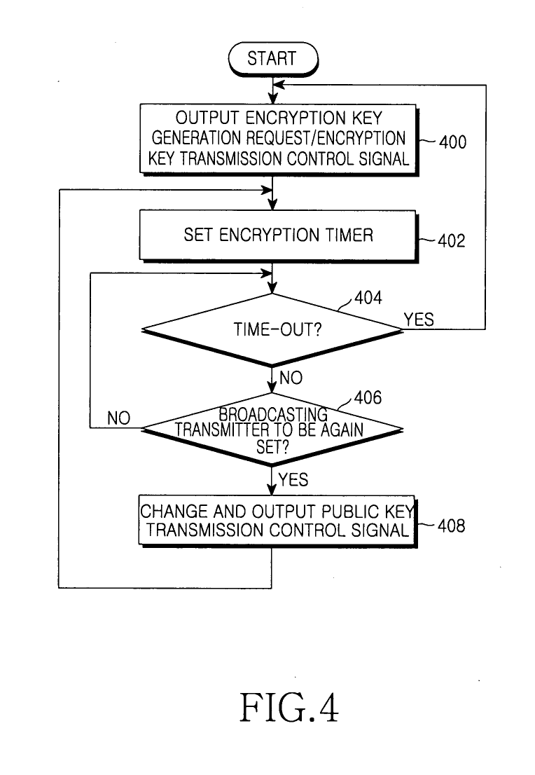

FIG. 4 is a flowchart illustrating a control process performed in the broadcasting controller of the broadcasting station in accordance with the present invention. An operation performed in the broadcasting controller 207 of the broadcasting station will be described with reference to FIG. 4.

The broadcasting controller 207 outputs an encryption key generation request signal to the encryption key generator 203 in order to provide a broadcasting service in step 400. Moreover, the broadcasting controller 207 generates a transmission control signal for transmitting public and private keys and outputs the generated transmission control signal to the transmitter 205 such that a particular broadcasting transmitter transmits a public key and the remaining broadcasting transmitters transmit a private key in step 400. Then, the broadcasting controller 207 proceeds to step 402 to set an encryption timer, which sets a time for maintaining an encryption key value, and can indicate an update period of an ECM and EMM used as a private key when the CAS is conventionally applied. The update period of the ECM and EMM conventionally uses a CIF counter. Thus, the timer can be replaced with the counter. Because a method for implementing the CIF counter is already known its detailed description is omitted herein. Hereinafter, the counter and the timer are referred to as timers.

After setting the encryption timer, the broadcasting controller 207 proceeds to step 404 to determine whether the timer has timed out. If the timer has timed out in step 404, the broadcasting controller 207 repeatedly performs steps 400-402 according to a method for transmitting keys for broadcasting transmitters stored in a memory (not illustrated) provided within the broadcasting controller 207. When this operation is performed, an encryption key can be periodically updated.

However, if the timer has not timed out as a determination result in step 404, the broadcasting controller 207 proceeds to step 406 to determine whether a request for again setting a broadcasting transmitter for transmitting a public key value is made through an operator interface (not illustrated) in FIG. 2. If a request for again setting a broadcasting transmitter for transmitting a public key value is made, the broadcasting controller 207 proceeds to step 408. Otherwise, the broadcasting controller 207 returns to step 404.

When proceeding from step 406 to step 408, the broadcasting controller 207 changes a control signal for transmitting a public key and outputs the changed control signal to broadcasting transmitters for transmitting the public key value input from an operator. Then, the broadcasting controller 207 returns to step 402. This control signal can be changed immediately. It is preferred that notification of the change is given in advance during a predetermined time for decrypting encrypted broadcasting service data. Notification of a time of applying a key value for decryption is to be exactly made in an entire cell managed by the transmitter. Broadcasting transmitters responsible for the above-described non-shadow region do not transmit a public key value. That is, only broadcasting transmitters responsible for the shadow region can be controlled to transmit, or not to transmit, a public key value. This limitation is not required in non-shadow regions, except a country or area in which a terrestrial DMB system is installed for public benefit as in some countries, such as South Korea, for example.

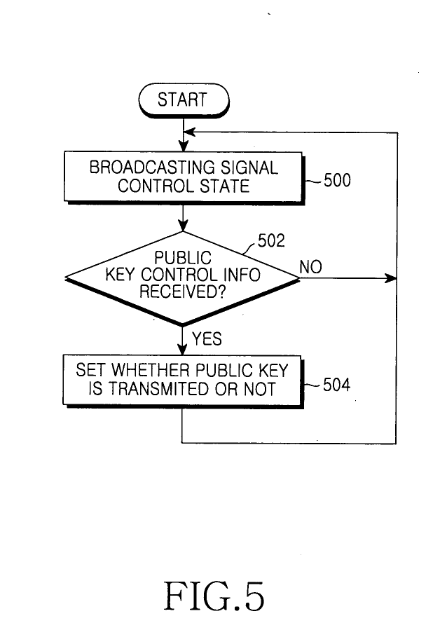

FIG. 5 is a flowchart illustrating a control process when a public key value is transmitted from the transmitter controller 217 of the broadcasting transmitter 105. The control process of FIG. 5 can be performed only in the broadcasting transmitter of the shadow region. However, the present invention is not limited to only a broadcasting transmitter of the shadow region.

The transmitter controller 217 of the broadcasting transmitter 105 maintains a broadcasting signal control state in step 500, in which a public key value received from the broadcasting station 100 is set to be transmitted or not to be transmitted. The broadcasting signal control state indicates a state for controlling broadcasting service data to be transmitted through the broadcasting signal transmitter 213. The transmitter controller 217 proceeds to step 502 to determine whether public key control information is received from the broadcasting station 100 while maintaining the broadcasting signal control state. That is, a determination is made as to whether a control signal is transmitted to request that an associated broadcasting transmitter send or change a public key value. When information for changing the transmission of a public key value is received, the transmitter controller 217 proceeds to step 504 to set the transmission of a public key value and output a setting result to the public key transmitter 215. Through this operation, the broadcasting transmitter 105 can or cannot transmit the public key value.

FIG. 6 is a block diagram illustrating an internal structure of a broadcasting receiver for receiving DMB broadcasting in accordance with the present invention.

A DMB broadcasting receiver receives broadcasting service data through an antenna, a broadcasting signal receiver 601, and a public key detector/receiver 611. Receivers 601 and 611 can be implemented in a single receiver 600. Herein, the broadcasting signal receiver 601 can receive a total frame, or can receive only the fast information channel 304 and the main service channel 306, as shown in FIG. 3. In the present invention, a signal to be received in the broadcasting signal receiver 601 is not limited. The public key detector/receiver 611 extracts only a part 300 in which a TII is transmitted among the parts 300 and 302 of the synchronization channel, and outputs a public key detection signal and a detected TII value to a second decryption key generator 613. Then, the second decryption key generator 613 generates a CW for decrypting encrypted broadcasting service data from the TII value used to transmit a public key value in accordance with the present invention and then outputs the generated CW to a selector 605. When the encryption scheme uses a scrambling scheme as described with reference to FIG. 2, the CW becomes information for descrambling in a broadcasting receiver.

The broadcasting signal receiver 601 outputs a private key value included and transmitted in the FIC 304 of the transmission frame or a private key value transmitted through a predetermined subchannel of the main service channel 306 to a first decryption key generator 603. Moreover, the broadcasting signal receiver 601 extracts encrypted broadcasting service data from CIFs included in the main service channel 306 of the transmission frame and then outputs the extracted encrypted broadcasting service data to a decrypter 607. The first decryption key generator 603 generates and outputs a CW for decrypting encrypted broadcasting service data on the basis of an ECM or EMM value corresponding to the private key value. When the encryption scheme uses a scrambling scheme as described with reference to FIG. 2, a CW for scrambling is generated and output. If two signals, i.e., public and private keys, as described with reference to FIGS. 1 and 2 are received, a CW value output from the first decryption key generator 603 is to be identical with that output from the second decryption key generator 613. Decryption key generators 603 and 613 can be implemented in a single decryption key generator 630.

The selector 605 outputs one of CWs output from the first and second decryption key generators 603 and 613. A controller 621 as described below controls the selector 605 to select the CW of the first decryption key generator 603 or the CW of the second decryption key generator 613. The CW value selected in the selector 605 is input to the decrypter 607. Upon receiving the CW value, the decrypter 607 decrypts encrypted broadcasting service data from the broadcasting signal receiver 601 and outputs the decrypted broadcasting service data to a Moving Picture Experts Group (MPEG) processor 623. When the encryption scheme uses a scrambling scheme, the decryption scheme can use a descrambling scheme. Of course, other encryption schemes can be applied.

If a terminal uses only a public key value, i.e., receives only a free broadcasting service, the first decryption key generator 603 and the selector 605 may not be provided. When a user is set to receive only a free broadcasting service, the first decryption key generator 603 cannot obtain ECM or EMM information and therefore cannot generate a CW. On the other hand, if a terminal uses a private key value as well as a public key value, i.e., desires to receive a broadcasting service also in the shadow region, it preferably includes both the first and second decryption key generators 603 and 613. However, an operation is possible even when only the first decryption key generator 603 is provided.

The broadcasting service data decrypted in the decrypter 607 as described above is input to the MPEG processor 623, and the MPEG processor 623 performs MPEG decoding. That is, the MPEG processor 623 decodes video and audio signals encoded in the terrestrial DMB scheme according to an associated decoding scheme. This decoding operation is performed under control of the controller 621. In a current terrestrial DMB scheme, a video compression method is based on an MPEG-4 standard. Accordingly, a decoding method of the terrestrial DMB scheme can be based on the MPEG-4 standard. When the decoding operation is performed, the MPEG processor 623 is connected to a memory 627 for temporarily storing data. Accordingly, when the decoding operation is not performed normally or correction is needed, video can be corrected using data stored in the memory 627.

Video and audio signals output from the MPEG processor 623 are input to a video/audio output unit 625. The video/audio output unit 625 can be implemented with a Liquid Crystal Display (LCD) for providing a video signal. An audio signal can be output through a speaker. The memory 627 includes an area for storing operation data necessary for control of the controller 621, an area for temporarily storing generated data at the time of control or storing information requested by a user, and an area for temporarily storing data from the MPEG processor 623. When both the first and second decryption key generators 603 and 613 are provided, the memory 627 is provided with an area for storing information indicating whether to first use either a public key or a private key in accordance with the present invention. A user interface 629 can input channel information desired by the user or other user information, and can be implemented in various forms such as a keypad, dial keys, a wheel dial, a touch pad, etc.

When the controller 621 receives a public key detection signal from the public key detector/receiver 611, it outputs a selection signal SEL indicating whether a public key value or a private key value is used. When a normal CW is generated from the first decryption key generator 603, the controller 621 disables the operations of the public key detector/receiver 611 and the second decryption generator 613 and performs a control operation such that only a private key value can be used. Accordingly, the controller 621 can be configured to receive information about the presence of error (not illustrated in FIG. 6) from the first decryption key generator 603.

Because the private key value is more accurate than the public key value, it is preferred that a terminal capable of receiving a private key value generates a CW using the private key value. That is, it is preferred that the selector 605 is connected to the first decryption key generator 603 in most cases. When the reception of a private key value is time-consuming and a public key value can be first used, the controller 621 can be configured to generate a selection signal SEL such that the public key value is used. In this case, the controller 621 must be configured to receive a CW generation signal (not illustrated in FIG. 6) from the first decryption key generator 603.

In FIG. 6, as described above, the receivers 601 and 611 can be implemented in one receiver. That is, one signal receiver can be implemented as indicated by reference numeral 600. The receivers 601 and 611 as illustrated in FIG. 6 are separated in order to clearly indicate received contents on a function-by-function basis. In FIG. 6, the decryption key generators 603 and 613 can be implemented in one decryption key generator. That is, one decryption key generator can be implemented as indicated by reference numeral 630.

FIG. 7 is a flowchart illustrating a control process of the receiver when DMB broadcasting service data is received in accordance with the present invention.

In step 700, the controller 621 maintains a waiting state (or a broadcasting signal control state). This state is a power-on state in which broadcasting reception is prepared. In the waiting state, the controller 621 proceeds to step 702 to determine whether the broadcasting reception is requested. The broadcasting reception request may be a request for receiving a particular broadcasting channel from the user interface 629. When the broadcasting channel reception is requested, the controller 621 checks information about a dedicated mode stored in the memory 627 and determines whether the dedicated mode is set to public key mode. If the dedicated mode is set to the public key mode, it means that the receiver is a terminal for reception only in the non-shadow region. This terminal can be implemented without the first decryption key generator 603 of FIG. 6.

If it is determined that the dedicated mode is set to the public key mode in step 704, the controller 621 proceeds to step 708 to output a selection signal SEL such that a CW of the second decryption key generator 613, i.e., a CW generated from the TII, can be output from the selector 605. However, if the dedicated mode is not set to the public key mode, the controller 621 proceeds to step 706 to output a selection signal SEL such that a CW of the first decryption key generator 603 can be output from the selector 605. Through this method, the controller 621 controls an operation for selecting one of signals of the first and second decryption key generators 603 and 613. In a terminal capable of using both the CWs output from the first and second decryption key generators 603 and 613, the generator capable of first outputting the CW between the two decryption key generators 603 and 613 is used, and the CW of the first decryption key generator 603 generated from the ECM or EMM value is stably used thereafter. When both decryption key generators 603 and 613 are used, the controller 621 controls the selector 605 to selectively provide the CWs output from the first and second decryption key generators 603 and 613 to the decrypter 607.

After the CW is generated through the above-described process, the controller 621 enters the broadcasting providing mode in step 710 in order to decrypt an encrypted broadcasting service and provide the decrypted broadcasting service to the user.

As described above, service fees can be selectively charged according to a shadow region and a non-shadow region in a DMB broadcasting system with a single frequency network. Because broadcasting service data can be more stably transmitted, public benefit can be promoted. Service providers can charge service fees to users desiring to receive a broadcasting service through a broadcasting transmitter in the shadow region, such that the efficiency of business can be improved. Because pay broadcasting is selectively provided, various services can be developed.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A digital broadcasting system for providing a broadcasting service through a defined frequency, comprising:
a broadcasting providing server for encrypting broadcasting service data, generating a private key and a public key into which predetermined encryption keys are divided to decrypt the encrypted broadcasting service data, setting at least one broadcasting transmitter for transmitting the private key and/or at least one broadcasting transmitter for transmitting the public key, and providing the encryption keys along with the encrypted broadcasting service data; and
broadcasting transmitters for transmitting the encrypted broadcasting service data received from the broadcasting providing server and the private key using the defined frequency, at least one of the broadcasting transmitters further transmitting the public key.

2. The digital broadcasting system of claim 1, wherein the public key is allocated to a Transmitter Identification Indicator (TII) to be transmitted during a null interval of a frame in which the broadcasting service data is transmitted.

3. The digital broadcasting system of claim 1, wherein the private key is allocated to Entitlement Checking Message (ECM) or Entitlement Management Message (EMM) information to be transmitted through a fast information channel of a frame in which the broadcasting service data is transmitted.

4. The digital broadcasting system of claim 1, wherein the broadcasting transmitters transmit only the private key in a service region in which service fees are charged.

5. The digital broadcasting system of claim 1, wherein the broadcasting transmitters transmit both the private key and the public key in a service region in which service fees are not charged.

6. The digital broadcasting system of claim 1, wherein the broadcasting providing server comprises:
a broadcasting controller for sending, to the broadcasting transmitters, control information for setting whether the public key is to be transmitted.

7. A digital broadcasting system for providing a broadcasting service through a defined frequency, comprising:
a broadcasting providing server for encrypting broadcasting service data and providing the encrypted broadcasting service data; and
broadcasting transmitters for receiving the encrypted broadcasting service data from the broadcasting providing server to transmit the encrypted broadcasting service data using the defined frequency, and transmitting a predetermined private key for decrypting the encrypted broadcasting service data along with the broadcasting service data, at least one of the broadcasting transmitters further transmitting a public key among encryption keys.

8. A method for providing a broadcasting service through a defined frequency in a digital broadcasting system, comprising the steps of:
encrypting broadcasting service data, generating a private key and a public key into which predetermined encryption keys are divided to decrypt the encrypted broadcasting service data, and transmitting the encrypted broadcasting service data and the encryption keys to broadcasting transmitters for transmitting the private key and/or the public key;
transmitting the encrypted broadcasting service data and the private key from the broadcasting transmitters using the defined frequency; and
further transmitting the public key from at least one of the broadcasting transmitters.

9. The method of claim 8, wherein the public key is allocated to a Transmitter Identification Indicator (TII) to be transmitted during a null interval of a frame in which the broadcasting service data is transmitted.

10. The method of claim 8, wherein the private key is allocated to Entitlement Checking Message (ECM) or Entitlement Management Message (EMM) information to be transmitted through a fast information channel of a frame in which the broadcasting service data is transmitted.

11. The method of claim 8, wherein the broadcasting transmitters transmit only the private key in a service region in which service fees are charged.

12. The method of claim 8, wherein the broadcasting transmitters transmit both the private key and the public key in a service region in which service fees are not charged.

13. A reception apparatus for receiving encrypted broadcasting service data from at least one broadcasting transmitter in a digital broadcasting system with the at least one broadcasting transmitter for transmitting the encrypted broadcasting service data through a defined frequency, comprising:
a receiver for receiving a public key and/or a private key for decrypting broadcasting service data from a frame of the broadcasting service data;
a decryption key generator for receiving the public key and/or a private key and generating at least one Control Word (CW) for decrypting the broadcasting service data using the public key and/or the private key; and
control means for controlling decryption key generator to generate the at least one CW and decrypting the broadcasting service data with the at least one generated CW according to a designated condition.

14. The reception apparatus of claim 13, wherein the public key is allocated to a Transmitter Identification Indicator (TII) to be transmitted during a null interval of a frame in which the broadcasting service data is transmitted.

15. The reception apparatus of claim 13, wherein the private key is allocated to Entitlement Checking Message (ECM) or Entitlement Management Message (EMM) information to be transmitted through a fast information channel of a frame in which the broadcasting service data is transmitted.

16. The reception apparatus of claim 13, wherein the designated condition indicates whether a subscriber is a pay service subscriber, and the control means selects the CW generated from the private key if the subscriber is the pay service subscriber.

17. The reception apparatus of claim 13, wherein the control means selects the CW generated from the public key in a service region in which service fees are not charged.

18. A reception method for receiving encrypted broadcasting service data from at least one broadcasting transmitter in a digital broadcasting system with the at least one broadcasting transmitter for transmitting the encrypted broadcasting service data through a defined frequency, comprising the steps of:
receiving a public key and/or a private key for decrypting the broadcasting service data from a frame of the broadcasting service data;
generating at least one Control Word (CW) for decrypting the broadcasting service data using the public key and/or the private key; and
decrypting the broadcasting service data with the at least one generated CW according to a designated condition.

19. The reception method of claim 18, wherein the public key is allocated to a Transmitter Identification Indicator (TII) to be transmitted during a null interval of a frame in which the broadcasting service data is transmitted.

20. The reception method of claim 18, wherein the private key is allocated to Entitlement Checking Message (ECM) or Entitlement Management Message (EMM) information to be transmitted through a fast information channel of a frame in which the broadcasting service data is transmitted.

21. The reception method of claim 18, wherein the designated condition indicates whether a user is a pay service user, and the CW is generated from the private key or the CW generated from the private key is selected among the at least one CW generated from the public key and/or the private key if the user is the pay service user.

22. The reception method of claim 18, wherein a CW is generated from the public key or the CW is selected among the at least one CW generated from the public key and/or the private key in a service region in which service fees are not charged.

23. The reception method of claim 18, further comprising:
determining whether a dedicated mode is set for only the public key according to the designated condition;
decrypting the encrypted broadcasting service data using the public key if the dedicated mode is set for only the public key; and
decrypting the encrypted broadcasting service data using the private key if the dedicated mode is not set for only the public key.
